(19) United States
(12) Patent Application Publication
(10) Pub. No.: US 2008/0002986 A1
(43) Pub. Date: Jan. 3, 2008

(54) Optical spatial communication method, optical transmission apparatus, optical reception apparatus, and optical spatial communication system

(75) Inventor: Futoshi Izumi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/898,062

(22) Filed: Sep. 7, 2007

Related U.S. Application Data
(63) Continuation of application No. PCT/JP2005/003940, filed on Mar. 8, 2005.

(51) Int. Cl. H04B 10/00

(52) U.S. Cl. 398/158

(57) ABSTRACT

Long-distance, high speed light spatial communication is realized by regulating light transmission timing in a plurality of light emitting elements arranged on a transmission panel in an optical transmission station so as to eliminate the difference in light path between individual beams of light caused by a condensing optical system or the like in an optical reception station. As a result, the communication can mitigate a modulation speed limit caused by a difference in light path between beams of light transmitted from individual light emitting elements to an optical reception station and also mitigate the deterioration of reception sensitivity.

### CROSS REFERENCE TO RELATED APPLICATION

This application is a continuation application of International PCT Application No. PCT/JP2005/003940 which was filed on Mar. 8, 2005.

### BACKGROUND OF THE INVENTION

1. Field of the Invention

The present invention relates to an optical spatial communication technique, and more specifically to an effective technique that can be applied to an optical spatial communication technique over a relatively long distance.

2. Description of the Related Arts

The recent development of blue diodes has completed the set of diodes for the three primary colors of light, that is, red, green, and blue. As a result, applications that have in the past been realized by electric light bulbs, color films, etc. have been replaced with applications using light emitting diodes in various fields. The diodes for traffic signals on the road are one typical example.

As compared with electric light bulbs, light emitting diodes excel not only in durability and power saving, but also in the capability to blink at a high speed, which has attracted much attention.

That is, since light emitting diodes can blink so quickly that our eyes cannot detect that they are blinking, they are expected to be highly effective not only for lighting but also as a communication technique through lighting equipment because they can be used as an optical communication system.

In conventional optical spatial communications, it is known that information can be transmitted by the blinking light of light emitting diodes or laser diodes (hereinafter referred to as light emitting elements). In optical spatial communications, the optical intensity attenuates more conspicuously in relation to the transmission distance than in communications through an optical transmission line such as an optical fiber. Therefore, optical spatial communications are limited to use for short distance communications.

Since optical spatial communications are performed not through an optical fiber waveguide but via propagation through space, optical spatial communications can easily become attenuated by floating objects in the air, thereby causing various technical problems in long-distance communications.

Accordingly, to realize communications over longer distances, it is necessary to use linear light such as a laser light so that transmission output can be improved and the attenuation of light caused by the diffusion of light can be prevented.

However, since it is generally dangerous to emit strong linear light signals such as laser light into the air, optical spatial communications are considered to be inferior to optical fiber communications from the viewpoint of safety.

That is, to guarantee a necessary optical signal level for information communications with the safety and attenuation of light during the spatial transmission taken into account, an optical signal is emitted with plural light emitting elements in a planar array, each of which is sufficiently low in power output from the viewpoint of safety, and light from the plural light emitting elements is converged and received on the receiver side.

However, since there is an optical path difference occurring between each beam of light emitted from the plural light emitting elements, the distortion of a signal waveform occurs via the optical path difference, thereby causing the technical problem of there being a modulation speed limit, that is, of the communication speed being reduced.

In addition, since, in optical spatial communications, information is transmitted as light into external space in which security management cannot be guaranteed, it is necessary to guarantee the confidentiality of information in communications. In this case, it is possible to maintain the confidentiality of information in communications in an encrypted system, but it is necessary to enhance the confidentiality of information in communications as compared with cable communications.

As a conventional technique, the invention described in patent document 1 discloses a light emission apparatus for optical wireless communications with an array of a plurality of light emitting diodes. The apparatus includes a grid frame unit for containing each light emitting diode and a lens array unit arranged at the aperture of the grid frame unit, and the apparatus realizes optical wireless communications with the light emitted from each light emitting diode converged as parallel pencils of light without any mixing of the light emitted from adjacent light emitting diodes and without the influence of external noise light.

However, patent document 1 does not solve the technical problems of the modulation speed limit being reduced by the optical path difference between each beam of light emitted from plural light emitting diodes, that is, of the communication speed being reduced, and of the confidentiality of information in communications needing to be guaranteed, etc.

Patent document 2 discloses a technique of improving the level of spatial light P that is detected by receiving the spatial light P during an optical spatial transmission using a plurality of optical antennas in place of an optical antenna having a large aperture, and regulating the phase of a received signal between a plurality of antennas such that the received signal level of each optical antenna can be the maximum.

However, patent document 2 does not consider that the modulation speed limit in optical spatial communications could be reduced by using a plurality of light emitting elements.
Patent Document 1: Japanese Laid-Open Patent Application No. H10-242912
Patent Document 2: Japanese Laid-Open Patent Application No. H11-55187

### SUMMARY OF THE INVENTION

The present invention aims at providing a technique capable of realizing longer-distance optical spatial communications with a large capacity and enhanced reliability, and a communication capability at the level of optical fiber communications, without using conventional optical fibers.

Another object of the present invention is to provide a technique capable of realizing a high confidentiality of information transmitted via optical spatial communications.

The first aspect of the present invention is an optical spatial communication method in which a reception unit converges light emitted from a plurality of light emitting elements included in a transmission unit in order to communicate information through the light. Then the transmission unit assigns a delay difference to the information to be transmitted in accordance with the optical path difference of each beam of light from each of the light emitting elements to the reception unit.

The second aspect of the present invention is an optical spatial communication method in which a reception unit converges a plurality of wavelengths of light emitted from a plurality of light emitting elements included in a transmission unit in order to communicate information through the light.

The transmission unit controls the transmission timing of the light from each of the light emitting elements in accordance with the optical path difference of each beam of light from each of the light emitting elements to the reception unit.

The third aspect of the present invention is an optical spatial communication method in which a reception unit converges a plurality of beams of light emitted from a plurality of light emitting elements of a transmission unit in order to communicate information through the light. Control is performed such that a plurality of center oscillation wavelengths of the light emitting elements can be prepared and the communication of information can be normally performed through the light when the light is converged in the position of the reception unit on the basis of the wavelength dependency of the propagation speed of the light.

The fourth aspect of the present invention is an optical spatial communication method in which a reception unit converges a plurality of beams of light emitted from a plurality of light emitting elements of a transmission unit in order to communicate information through the light.

The transmission modulation of the light in the transmission unit is controlled such that the information can be normally communicated when a plurality of communication paths are set between the transmission unit and the reception unit and the reception unit is located in a place where the communication paths cross.

The fifth aspect of the present invention is an optical transmission apparatus configuring an optical spatial communication system with an optical reception apparatus, and includes: a plurality of light emitting elements; a delay generation unit for controlling transmission timing of the light from each of the light emitting elements in accordance with the optical path difference between a plurality beams of light emitted from each of the light emitting elements and reaching the reception apparatus.

The sixth aspect of the present invention is an optical transmission apparatus configuring an optical spatial communication system with an optical reception apparatus, and includes: a plurality of light emitting elements having different center oscillation wavelengths of emitted light; and a delay generation unit for controlling transmission timing of the light from each of the light emitting elements so that a normal received waveform can be obtained when the light is converged at a position of the optical reception apparatus.

The seventh aspect of the present invention is an optical reception apparatus configuring an optical spatial communication system with an optical transmission apparatus, and includes: a condensing unit for converging a plurality beams of light from a plurality of light emitting elements provided in the optical transmission apparatus; and an optical path regulation unit for eliminating each optical path difference of the light between the optical transmission apparatus and the optical reception apparatus.

The eighth aspect of the present invention is an optical spatial communication system having an optical transmission apparatus and an optical reception apparatus, and includes an optical path regulation unit for eliminating the optical path difference between a plurality beams of light reaching from a plurality of light emitting elements provided in the optical transmission apparatus.

The ninth aspect of the present invention is an optical spatial communication system having an optical transmission apparatus and an optical reception apparatus. Then the optical transmission apparatus includes a plurality of light emitting elements and a delay generation unit for controlling transmission timing of the light in each of the light emitting elements to eliminate the optical path difference between a plurality of light reaching from the light emitting elements to the optical reception apparatus.

Although it is dangerous to emit high-power light into space, the dangerousness of light is evaluated by output power per unit area. Therefore, it is possible to extend the possible communication distance by having the light be emitted from low-power light emitting elements and put in a predetermined distribution and then converging the light on a receiver side.

However, this method has a problem when it is used as an optical communication system because the light is only distributed spatially. That is, since the difference in the propagation speed of the light that has passed each path distorts the signal waveform, the modulation speed limit is imposed.

For example, since a time difference of about 3 ns occurs with an optical path difference of 1 m only, it is necessary to reduce the modulation speed if a large spatial range of the light is requested.

Therefore, according to the present invention, each optical path length of light from a transmitter to a receiver can be unified by regulating the blinking time of the light of each light emitting element on the transmitter with the optical path length taken into account, and the receiver receives the light after converging the beams of light whose optical path lengths are unified. Thus, the reception sensitivity can be enhanced, and optical spatial communications can be realized for a longer distance.

That is, when a delay generation unit is provided for a transmitter, and each of a plurality of light emitting elements is driven according to each modulation signal corresponding to each of a plurality of light emitting elements, the delay timing of emitted light is optimally regulated for each light emitting element on the transmitter side so that the optical path length can be unified in the receiver at which light emitted from each light emitting element is received.

Furthermore, when the communication distance is extended, and when the spectrum characteristic of the output light of a light emitting element has a predetermined range, there arises the problem of a dispersion effect, which refers to the distortion of a waveform as the distance of the spatial propagation becomes longer because the transmission speed is dependent upon wavelength. Therefore, according to the present invention, an optical filter is provided on the receiver to selectively extract only the light of the center wavelength using the optical filter, thereby removing unnecessary wavelengths, reducing the distortion of the waveform, and realizing correct reception of an optical signal.

Furthermore, use of the optical filter can also be effective when spectrums increase due to the fluctuation of the oscillation wavelength of a light emitting element after modulation.

In this case, the optical filter allows only a portion of the a plurality of beams of light emitted by light emitting elements to pass and removes unnecessary portions. As a result, the light used for communications is only a portion of the light. However, it is convenient from the viewpoint of reception sensitivity improvement to multiplex the removed light as long as the regulation can be performed on the propagation delay portion. Therefore, the light can be converged after performing wavelength separation at predetermined intervals and adding the respective delays. The delay can be effected using a curved mirror or other such device designed so that it brings difference among optical paths for each of wavelengths.

On the other hand, an effective way to guarantee the confidentiality of information transmitted via optical spatial communications is to prevent light propagating in space from diffusing to any location other than the receiving station and to allow data to be identified only at the position of the receiving station. Therefore, according to the present invention, the wavelength of each beam of light output from a plurality of light emitting elements arranged in the transmitter is set to be different in order to generate a shift in propagation speed according to a different propagation speed is assigned to each wavelength of light and an optical path difference is created by convergence. Using this method, the reception station can be arranged at a particular position at a specific distance from the transmitter since a signal satisfying the reception sensitivity can be converged only at a position of a specific distance from the transmitter, and the confidentiality on information of communications can thereby successfully be enhanced.

Furthermore, when the light emitted from the optical transmission station is received by a receiving station by way of a plurality of different paths and data is retrieved from the light reaching the optical reception station through each path, the received data cannot be easily obtained by anything but the optical reception station, thereby reducing the possibility of tapping.

A large transmission capacity can be obtained by collectively transmitting a plurality of beams of light having different wavelengths and individually regenerating data after separating the data using a wavelength filter on the receiver side.

Propagating light having the diffuse range in space described above can prevent communication interference by floating objects or other obstacles in space.

However, in situations in which there may exist the influence of large obstacles, a dense fog, etc., communication interference would be anticipated. Therefore, according to the present invention, a redundant optical path is provided between the transmitter and receiver; communication interference is avoided by selecting one of the plural pieces of received data received by each redundant optical path.

When delay regulation is performed on a transmitter side with the convergence characterization of a receiver taken into account, a transmitter can also perform delay regulation by monitoring the light reception status of the receiver. In this case, a notification unit for notifying the transmitter by measuring the reception status of the receiver can be provided and the transmitter can use the notification unit to obtain a set value for delay regulation and set a delay set value for each beam of light emitted by the light emitting elements.

At this time, a method for obtaining a delay difference between beams of light emitted by light emitting elements is described in the following example. In signals of a constant period, for example, which be constantly modulated a plurality of beams of light emitted by all the light emitting elements by using a device alternating 1 (with output) or 0 (without output), one or more groups in the signals can be selected, and a delay amount can be selected such that the amplitude alternating as 1 or 0 can be the maximum. The period alternating as 1 or 0 is set such that the period falls below the delay difference by an anticipated optical path difference.

Furthermore, leakage of signal data can be avoid by providing a plurality of paths to converge received signals in a receiver so that the plurality of paths can be switched, and by notifying a transmitting station, from a receiving station, of the switching status of the selected path and the delay amount of the selected path in converging light, and by appropriately changing delay settings for controlling delay in the transmitting station on the basis of the switching status and the delay amount of the selected path notified by the receiving station. The switching of the path can also be changed to correspond to a particular destination address.

### BRIEF DESCRIPTION OF THE DRAWINGS

FIG. 1 shows an example of a configuration of the optical spatial communication system according to a mode for embodying the present invention;

FIG. 2 shows an example of a configuration of an optical transmission station in the optical spatial communication system according to a mode for embodying the present invention;

FIG. 3 shows an example of a configuration of an optical reception station in the optical spatial communication system according to a mode for embodying the present invention;

FIG. 4 shows an operation of. the optical spatial communication system according to a mode for embodying the present invention;

FIG. 5 shows an operation of the optical spatial communication system according to a mode for embodying the present invention;

FIG. 6 shows a variation of the optical spatial communication system according to a mode for embodying the present invention;

FIG. 7 shows a variation of the optical spatial communication system according to a mode for embodying the present invention;

FIG. 8 shows a variation of the optical spatial communication system according to a mode for embodying the present invention;

FIG. 9 shows a variation of the optical spatial communication system according to a mode for embodying the present invention;

FIG. 10 shows a variation of the optical spatial communication system according to a mode for embodying the present invention;

FIG. 11 shows a variation of the optical spatial communication system according to a mode for embodying the present invention;

FIG. 12 shows a variation of the optical spatial communication system according to a mode for embodying the present invention;

FIG. 13 shows a variation of the optical spatial communication system according to a mode for embodying the present invention;

FIG. 14 shows a variation of the optical spatial communication system according to a mode for embodying the present invention;

FIG. 15 shows a variation of the optical spatial communication system according to a mode for embodying the present invention;

FIG. 16 shows a variation of the optical spatial communication system according to a mode for embodying the present invention;

FIG. 17 shows a variation of the optical spatial communication system according to a mode for embodying the present invention;

FIG. 18 shows an example of a configuration of the reception circuit unit in a variation of the optical spatial communication system according to a mode for embodying the present invention; and

FIG. 19 shows a variation of the optical spatial communication system according to a mode for embodying the present invention.

### DESCRIPTION OF THE PREFERRED EMBODIMENTS

The mode for embodying the present invention is described below in detail by referring to the attached drawings.

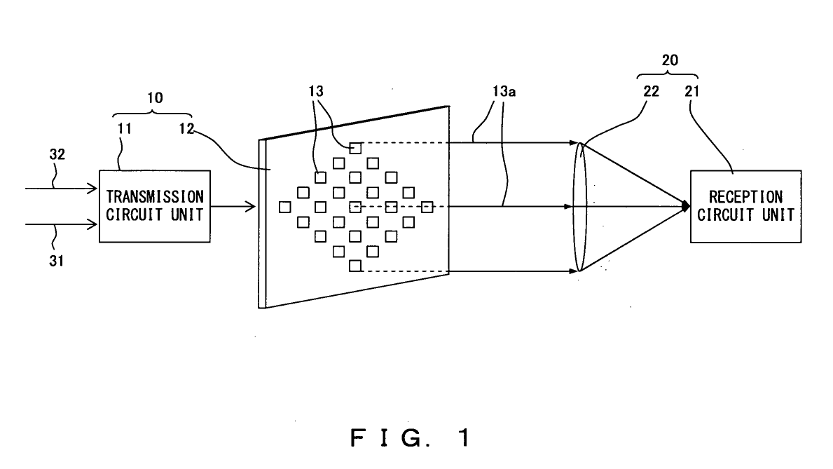

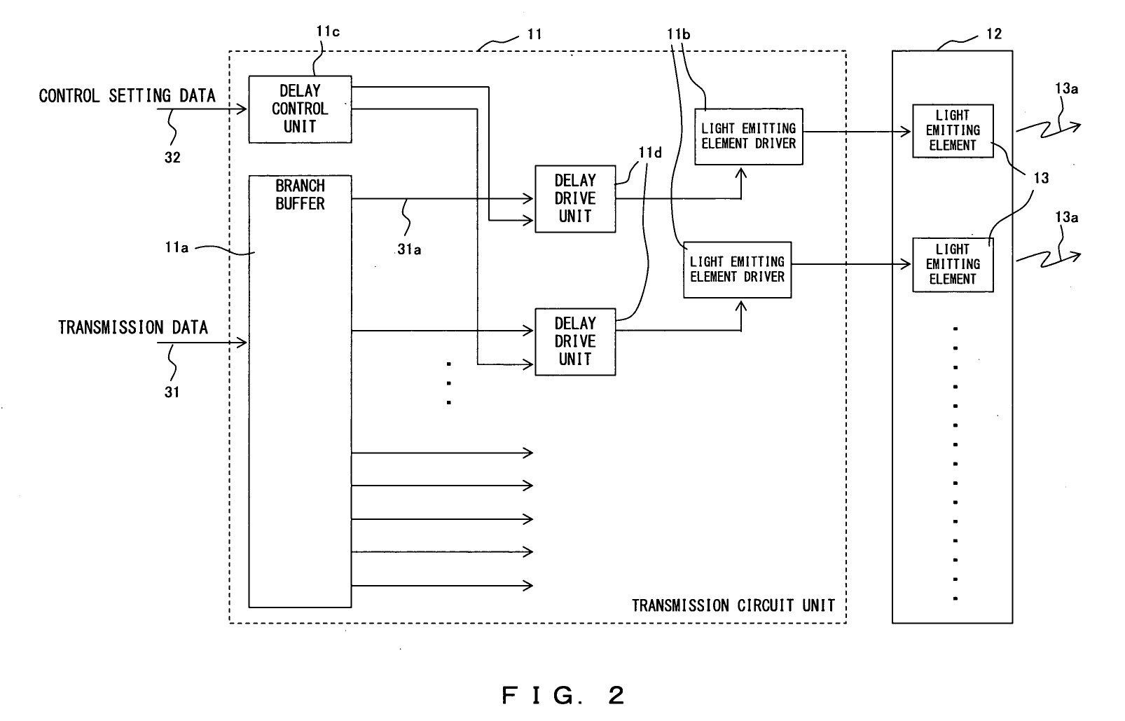

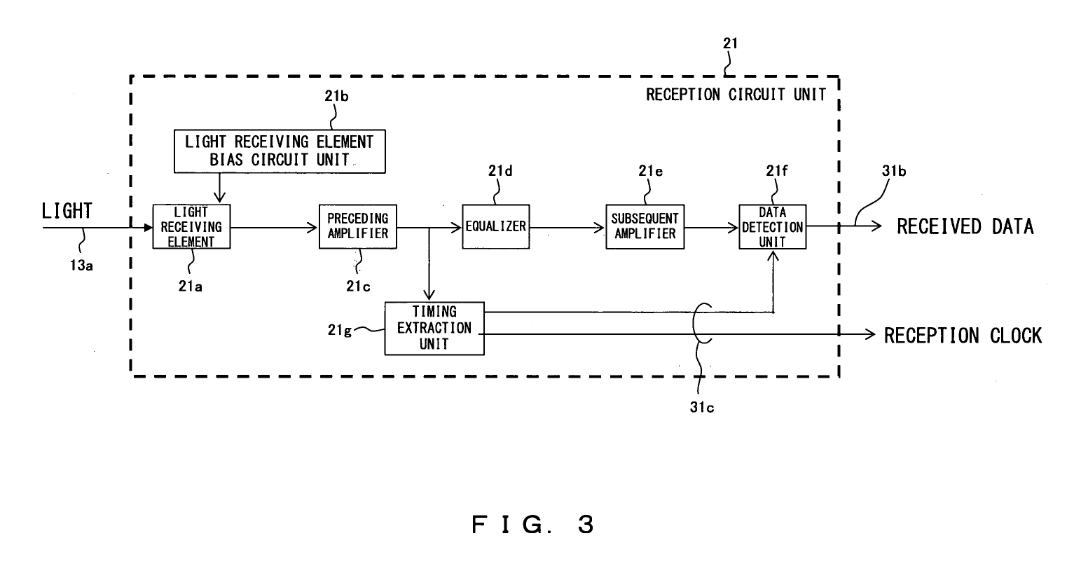

FIG. 1 shows an example of a configuration of the optical spatial communication system according to a mode for embodying the present invention. FIG. 2 shows an example of a configuration of an optical transmission station in the optical spatial communication system according to a mode for embodying the present invention. FIG. 3 shows an example of a configuration of an optical reception station in the optical spatial communication system according to a mode for embodying the present invention.

The optical spatial communication system according to a mode for embodying the present invention includes an optical transmission station 10 and an optical reception station 20.

The optical transmission station 10 is provided with a transmission circuit unit 11 and a transmission panel 12. A plurality of light emitting elements 13 are arranged on the transmission panel 12, and light 13a is emitted from each light emitting element 13 to the transmission panel 12.

The optical reception station 20 is provided with a reception circuit unit 21 and a condensing optical unit 22.

As exemplified in FIG. 2, in the optical transmission station 10, the transmission circuit unit 11 is provided with a branch buffer 11a, a light emitting element driver 11b, a delay control unit 11c, and a delay drive unit 11d.

The branch buffer 11a branches transmission data 31 into branch transmission data 31a for the plurality of light emitting elements 13.

The light emitting element driver 11b emits the light 13a by driving the light emitting element 13 using the branch transmission data 31a input from the branch buffer 11a.

The delay control unit 11c controls the delay time in the delay drive unit lid on the basis of externally input control setting data 32. The delay drive unit 11d provided between the branch buffer 11a and the light emitting element driver 11b controls the output timing of the light 13a emitted by each light emitting element 13 by individually delaying the input timing to the light emitting element 13 of the branch transmission data 31a at a command from the delay control unit 11c.

On the other hand, as exemplified in FIG. 3, the reception circuit unit 21 is provided with a light receiving element 21a, a light receiving element bias circuit unit 21b, a preceding amplifier 21c, an equalizer 21d, a subsequent amplifier 21e, a data detection unit 21f, and a timing extraction unit 21g.

The light receiving element 21a converts the incident light 13a into an electric signal by being driven by the light receiving element bias circuit unit 21b.

The electronic signal output from the light receiving elements is amplified at the preceding amplifier 21c and performs a waveform equalization at the equalizer 21d and is further amplified at the subsequent amplifier 21e and is converted into the received data 31b at the data detection unit 21f.

The timing extraction unit 21g extracts a received clock 31c from the electric signal output from the preceding amplifier 21c and a part of the received clock 31c is used for extracting the received data 31b in the data detection unit 21f.

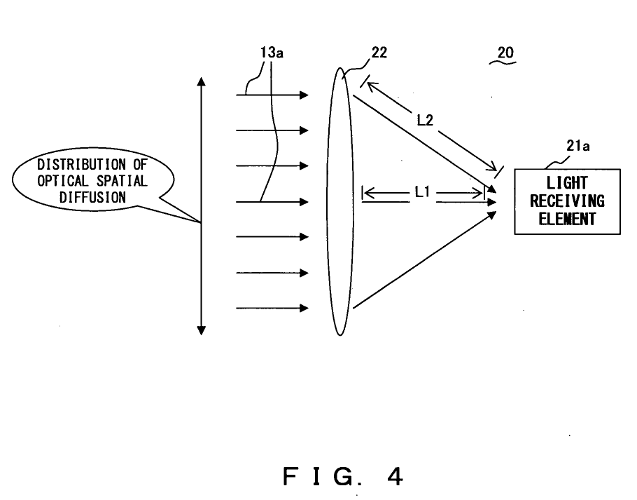

For example, consider sixteen light emitting elements 13 arranged at equal intervals on the 1 m×1 m square transmission panel 12. When the light 13a passing straight in parallel is converged at the optical reception station 20, and if it is converged by the condensing optical unit 22 of a simple lens structure, there occurs an optical path difference (ΔL=L2−L1) as shown in FIG. 4. The optical path difference ΔL after the convergence is (√⁻5−1)×0.5=0.618 m at maximumin this example, and therefore there occurs a difference in the delay of the input timing of the light 13a of about 2 nsec. to the light receiving element 21a. Assume that the refractive index of air is approximately 1. Thus, if the modulation speed is 2.5 Gbps, the width of one time slot is only 400 psec. Data can be identified without any complications using a waveform of the light 13a received at the light receiving element 21a if the optical path difference ΔL is controlled and regulated to at least be below 100 psec.

That is, according to the mode for embodying the present invention, by inputting the control setting data 32 to the delay control unit 11c of the transmission circuit unit 11, the optical path difference of the light 13a emitted from each light emitting element 13 reaching the optical reception station 20 is controlled and regulated below 100 psec.

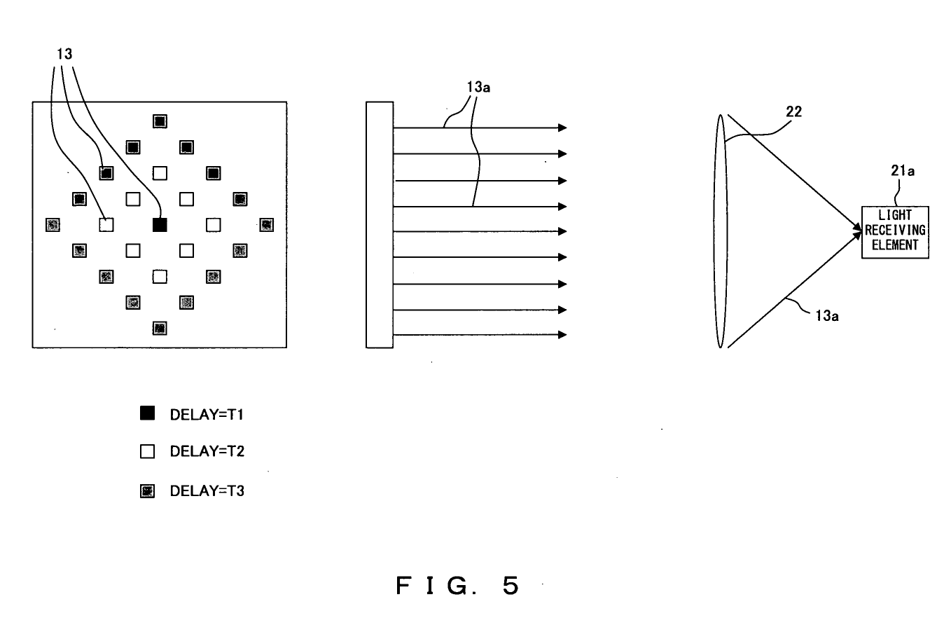

For example, as exemplified in FIG. 5, in the light emitting element 13 positioned at the center of the transmission panel 12 corresponding to the area around the optical axis of the condensing optical unit 22, and in the light emitting elements 13 around the central element, the timing (T1, T2) of the light 13a emitted by the light emitting element 13 at the center that has a short optical path for the light 13a to the optical reception station 20 is controlled and delayed in relation to the timing (T3) of the light emitted by the surrounding light emitting elements 13. Thus, the optical path lengths of the light 13a that entered the light receiving element 21a in the reception circuit unit 21 can be unified.

The wavelength of the light 13a used in the transmission should take into account the sensitivity of the eyes of persons to the light that is emitted in the space. Preferable, a long wavelength band that cannot be easily absorbed in the air and that is outside the visible wavelength band should be used; in this way, transmission loss of the light can be suppressed. In addition, since the reduction of OH absorption by OH groups in the moisture contained in the air has a large influence, the 1.4 micron band should be avoided.

However, if the light 13a has too long a wavelength, the light will be easily diffused. Therefore, it is necessary for the optical transmission station 10 to provide and use units for regulating a pencil of light. Therefore, it is preferable to select a wavelength of the light 13a outside the visible light wavelength band, toward the longer wavelength side or the short wavelength side.

Assuming that the output of the light 13a of each light emitting element 13 is −5 dBm at a safe level and the reception level at 2.4 Gbps of a light receiving element is −28 dBm, there is a system gain of −5+10 LOG (16)−(−28)=35 dB.

Assuming that the transmission loss by spatial propagation is 1 dB/km, the power for compensating the loss corresponding to 35 km can be guaranteed.

Thus, the influence of the optical path difference of the light 13a emitted from each light emitting element 13 can be removed, and long distance optical spatial communications of a communication speed equal to or higher than a communication speed in using an optical fiber can be realized.

Each wavelength oscillation phase of the light 13a of the plurality of light emitting elements 13 of the optical transmission station 10 is set at random, not in synchronization with each other, and there are natural variances in oscillation frequency.

When the distance between the optical transmission station 10 and the optical reception station 20 is extended, and when the spectrum characteristic of the light 13a output by the light emitting element 13 has a predetermined range, there arises a problem of a dispersion effect, which refers to the distortion of a waveform as the distance of the spatial propagation becomes longer, because the transmission speed depends on the wavelength.

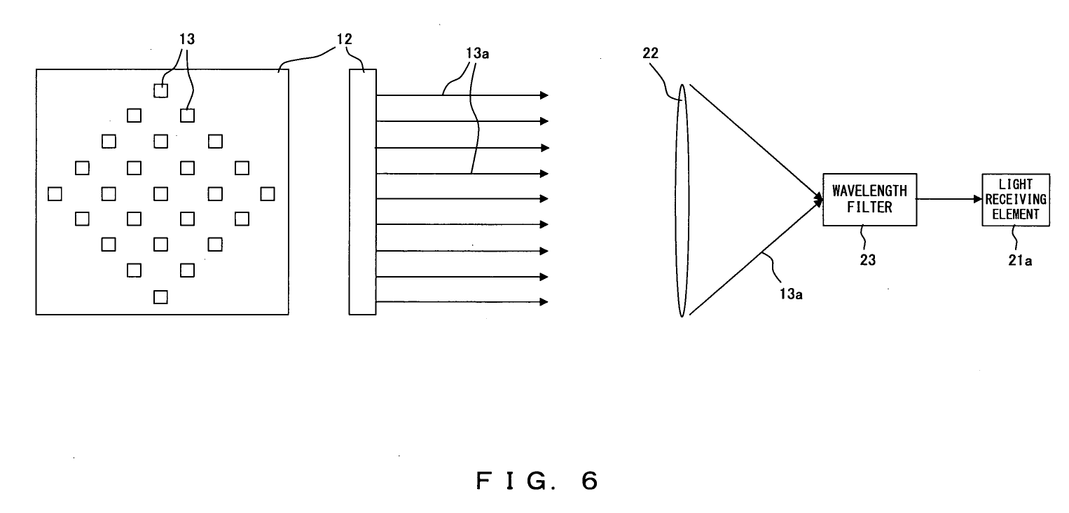

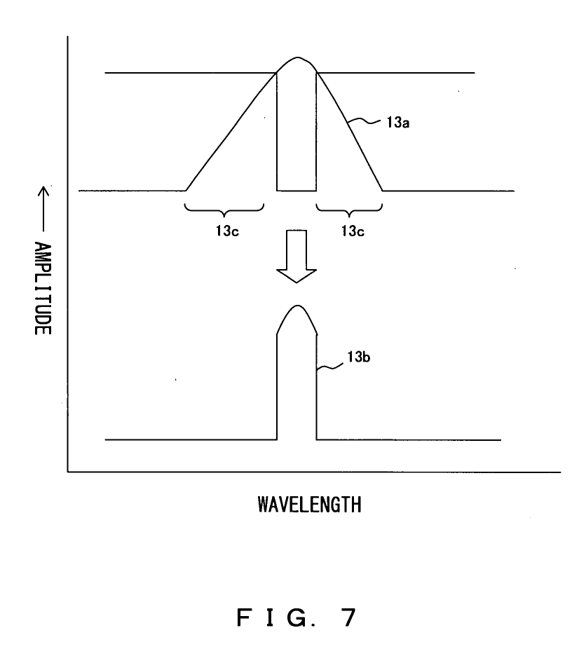

Therefore, as an example of a variation of the mode for embodying the present invention exemplified in FIGS. 6 and 7, at the optical reception station 20, a wavelength filter 23 is provided at a stage subsequent to the condensing optical unit 22, and only a center wavelength 13b is extracted from the light 13a by the wavelength filter 23 (optical filter) in order to remove excess waveforms (unnecessary spectrum components 13c) and reduce the distortion in waveform, thereby allowing the successful reception of a signal of a correct waveform.

Furthermore, the wavelength filter 23 has an effect when there is an increasing spectrum due to the fluctuation of the oscillation wavelength of light emitted by the light emitting element 13; this fluctuation occurs due to the modulation of the light.

That is, the beams of light, which extended the range of the wavelength spectrum and which were emitted by light emitting elements 13, which are inexpensive, can be used by using the wavelength filter 23 that removes the unnecessary spectrum components which are a deformation of the waveform that are caused by the differences among the propagation speeds, so that the influence of the group speed dispersion that occurred due to the propagation through space of the beams can be suppressed, thereby alleviating the modulation speed limit and realizing an increased communication speed.

In this case, since the wavelength filter 23 removes the unnecessary spectrum components and allows only a portion of the light 13a of the light emitting element 13 to pass, only a portion of the light 13a is used for communications. However, if regulation for the delayed propagation amount of the removed light 13a can be performed, the removed light 13a after multiplexing the wavelengths of the regulated removed light 13a can again be used; thus, this is more convenient from the view point of noise resistance etc. because the amplitude of the received signal is enhanced.

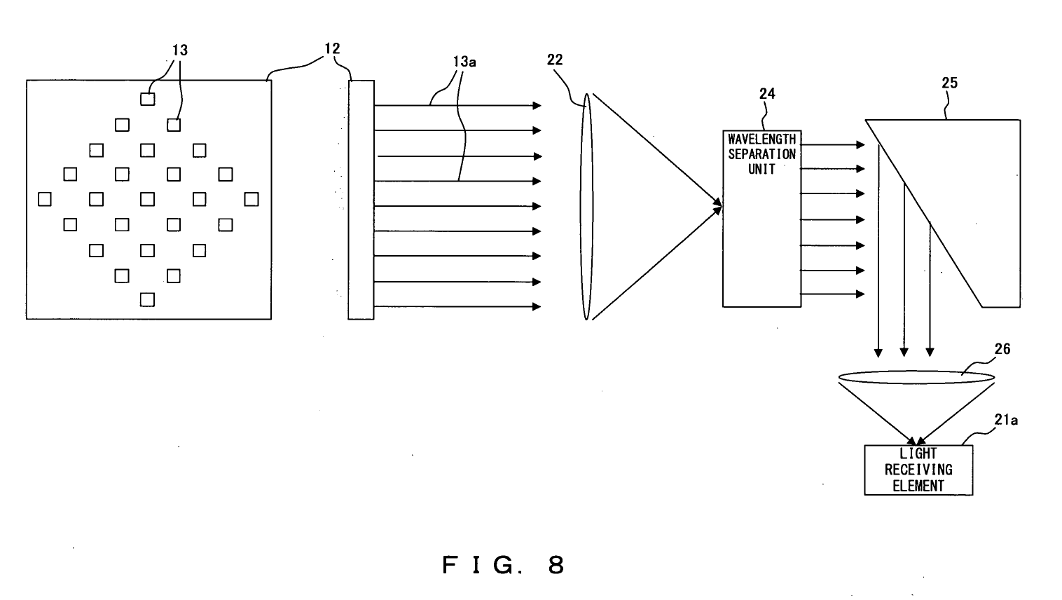

As exemplified in FIG. 8, a wavelength separation unit 24, an optical path length corrector 25, and a condensing optical unit 26 are arranged on the optical path of the light 13a between the condensing optical unit 22 and the light receiving element 21a, the light 13a is separated by a predetermined wavelength interval, respective delay values are added for each beam of separated light, and each beam of separated light can be converged to the light receiving element 21a. The optical path length corrector 25 for correcting the delay can use a curved surface mirror or other such object designed with a subtle difference in optical path length of the reflected light 13a. The optical path length corrector 25 can also use, for example, an optical element such as a VIPA (virtually imaged phased array).

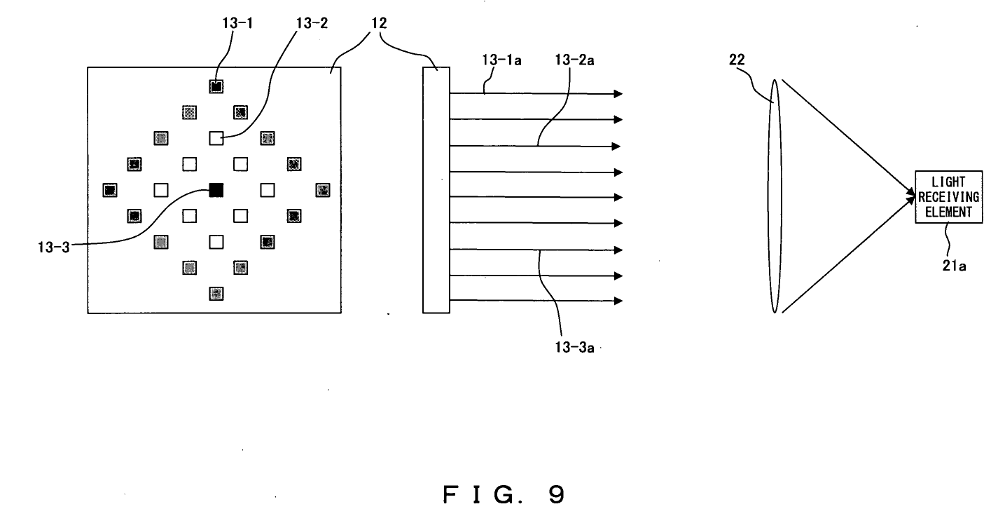

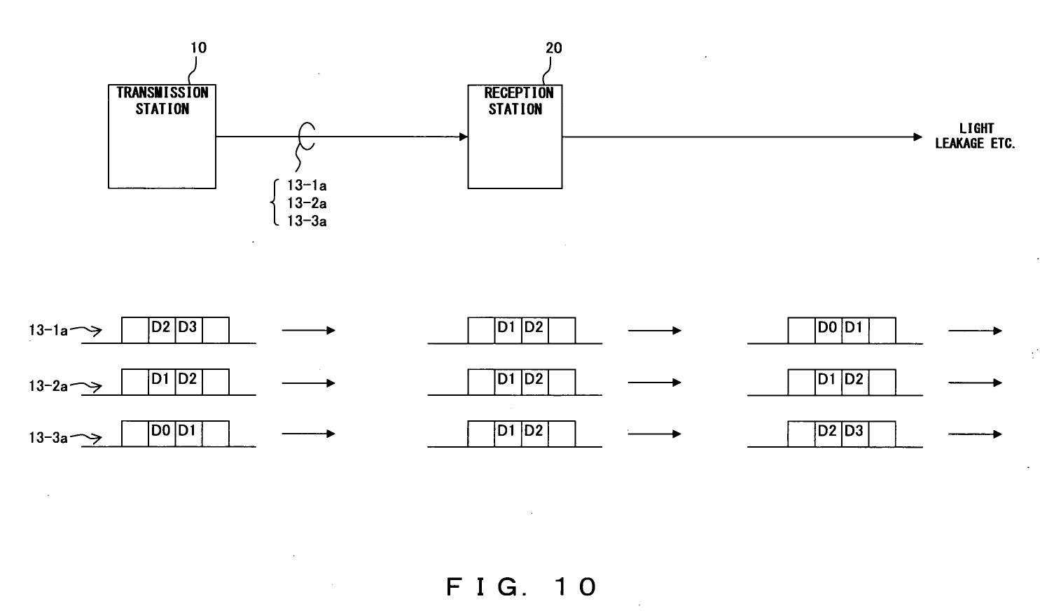

Described below is an example of realizing a guarantee of confidentiality of information transmitted via optical spatial communications between the optical transmission station 10 and the optical reception station 20 according to the mode for embodying the present invention with reference to FIGS. 9 and 10.

That is, when the confidentiality of information in communications is to be guaranteed, the light 13a is protected from being diffused outside the area of the optical reception station 20, and data can be identified only at the position of the optical reception station 20 by setting the wavelengths of the light 13-1a, 13-2a, and 13-3a emitted from each of the plurality of light emitting elements 13-1, 13-2, and 13-3 arranged on the transmission panel 12 of the optical transmission station 10 as plural different types of wavelengths, because, in addition to the path difference that results from the convergence on the optical reception station 20 side, there occurs a difference in propagation speed that results from the differences in wavelength of the light. On the basis of this, a signal satisfying the reception sensitivity can be converged only at a specific distance, thereby successfully guaranteeing an improvement in the confidentiality of information in communications.

That is, plural pieces of data D0 through D3 carried by the light 13-1a, 13-2a, and 13-3a can normally be received only when these data are converged at the position of the optical reception station 20, as shown in FIG. 10, by generating a difference of the transmission line on the basis of each of the different wavelengths of the light by using a plurality of light emitting elements 13-1 to 13-3 and appropriately selecting each wavelength of the light 13-1a, 13-2a, and 13-3a.

For example, even though the light 13-1a to 13-3a transmitted at the optical transmission station 10 is converged as shown on the left side of FIG. 10, the wavelength-multiplexing cannot successfully perform reconstruction for the data strings because the each data string is intentionally shifted. When the light 13-1a to 13-3a is converged around the position of the optical reception station 20 as shown at the center of FIG. 10, the wavelength-multiplexing can perform reconstruction for the data strings because the each data string overlaps. Also, even though the leaked light 13-1a to 13-3a at a distant location from the optical reception station 20 is converged as shown at the right side in FIG. 10, the wavelength-multiplexing cannot successfully perform reconstruction for the data strings because each data string is shifted.

Thus, in optical spatial communications between the optical transmission station 10 and the optical reception station 20, a high confidentiality of information in communications can be realized.

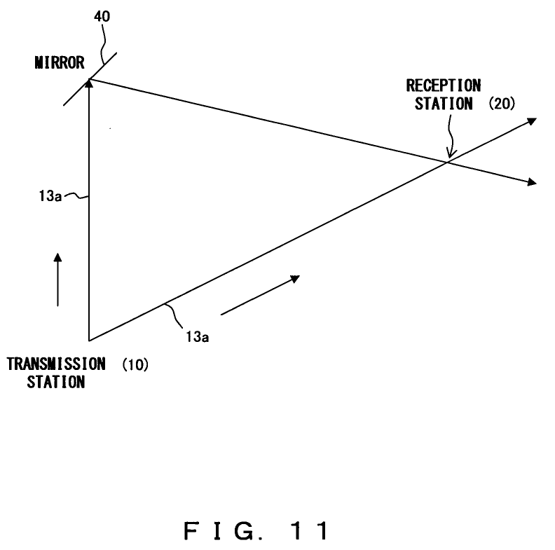

Another example of guaranteeing the confidentiality of information in communications using a plurality of paths is described below by referring to FIG. 11. In the example shown in FIG. 11, the data to be transmitted is divided into two data strings that are transmitted through separate paths. One is directly transmitted to the optical reception station 20 from the optical transmission station 10, and the other is transmitted along a path that goes byway of a mirror 40. The optical reception station 20 receives the both data strings transmitted through the direct path and the path that goes by way of the mirror 40 and can reconstruct the original data strings.

Thus, the optical reception station 20 receives the data at the point where the two different paths cross each other and reconstructs information from the data through the two paths. Even though the light 13a transmitted from the optical transmission station 10 is dispersed light, the data can be received at a single point by appropriately selecting the position of the mirror 40.

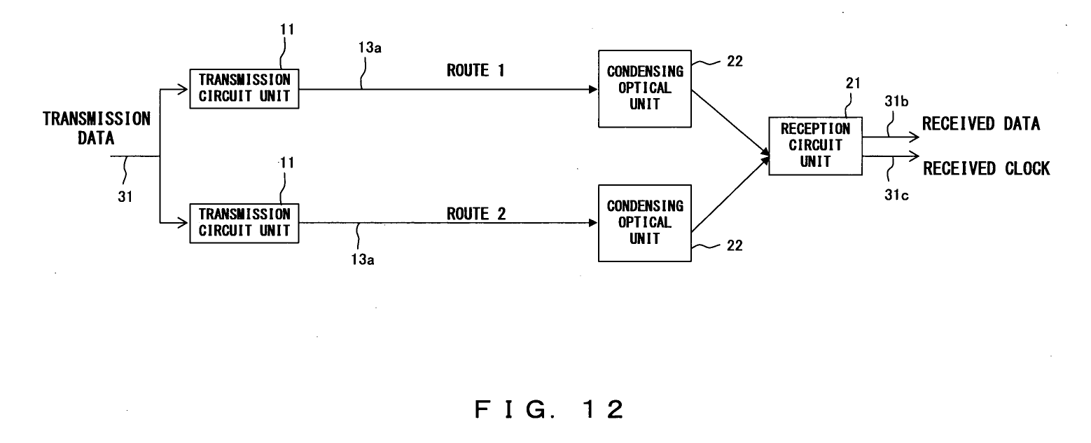

Furthermore, if the optical reception station 20 receives the light through a plurality of paths and the data is retrieved from the two beams of light as exemplified in FIG. 12, the received data cannot be easily acquired by any receiver other than the optical reception station 20, thereby reducing the possibility of tapping. That is, in the example shown in FIG. 12, in the optical transmission station 10, a plurality of beams of light 13a are transmitted to the optical reception station 20 using the transmission circuit unit 11 for transmitting the transmission data 31. In the optical reception station 20, a plurality of beams of light 13a are separately received using a plurality of condensing optical units 22, and the reception circuit unit 21 combines the received data and outputs received data 31b and received clock 31c.

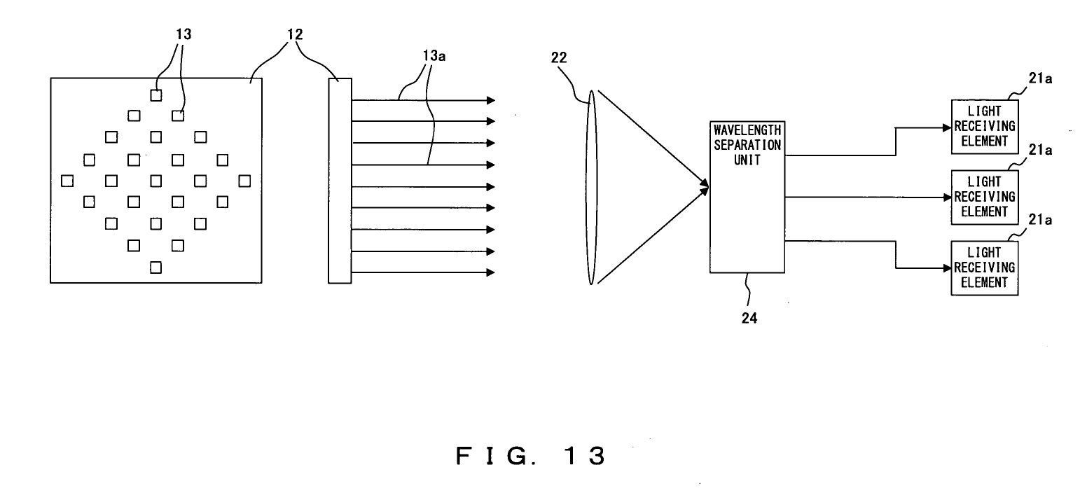

As exemplified in FIG. 13, the beams of light 13a having different wavelengths are collectively transmitted by the light emitting elements 13 at the optical transmission station 10, the wavelength separation unit 24 such as a wavelength filter or other such device separates the light on the receiver side, and the beams of light are received by a plurality of light receiving elements 21a provided for each wavelength, thereby also increasing the transmission capacity. That is, when n types are set as wavelengths of the light 13a and the optical reception station 20 detects the light 13a individually in relation to each wavelength, the communication speed can be realized at n times the speed in the case of a single wavelength.

As exemplified in FIG. 12, using a propagating light with spatial range can prevent a communication error caused by a floating object or an obstacle in the air.

Furthermore, because influences such as large obstacles, dense fog, etc. are taken into account, a plurality of redundant paths for carrying the same data are provided, and the data from one of the two beams of light is selected, thereby avoiding any interference in communications that might be caused by large obstacles, dense fog, or other such problems.

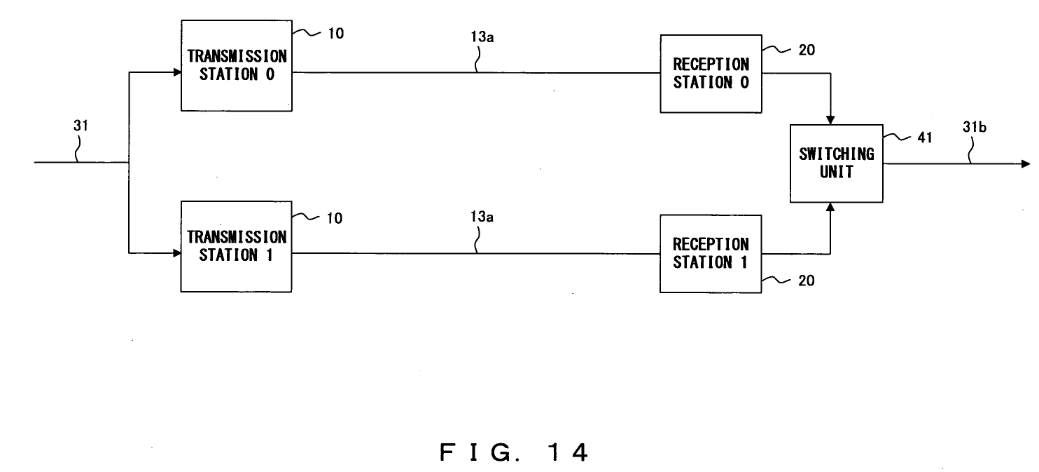

That is, in the example shown in FIG. 14, a plurality of corresponding optical transmission stations 10 and optical reception stations 20 are provided at the transmitter and the receiver, the same data is transmitted through multiplexed paths, and a switching unit 41 provided at the receiver selects the data of any communication path and outputs the selected data as received data 31b.

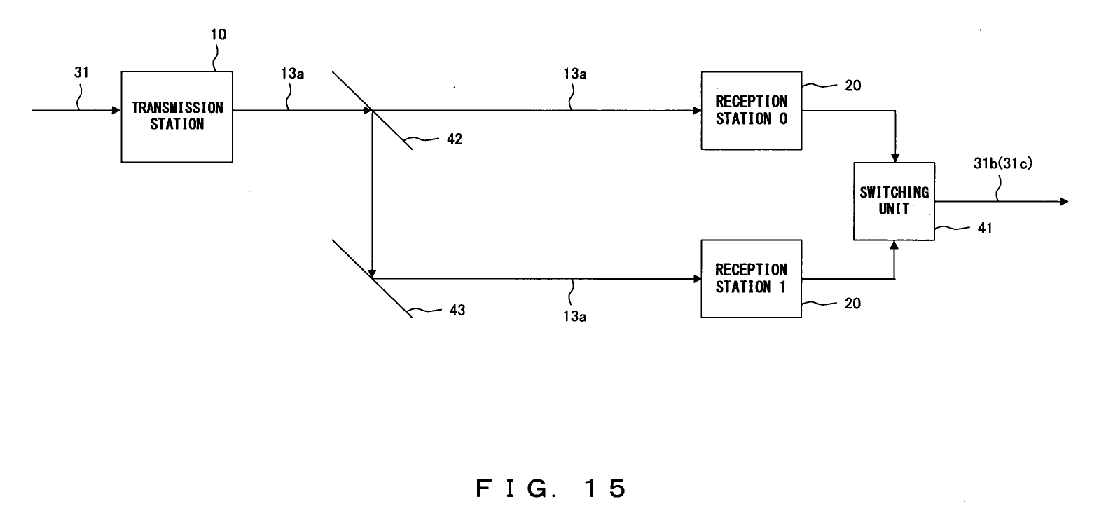

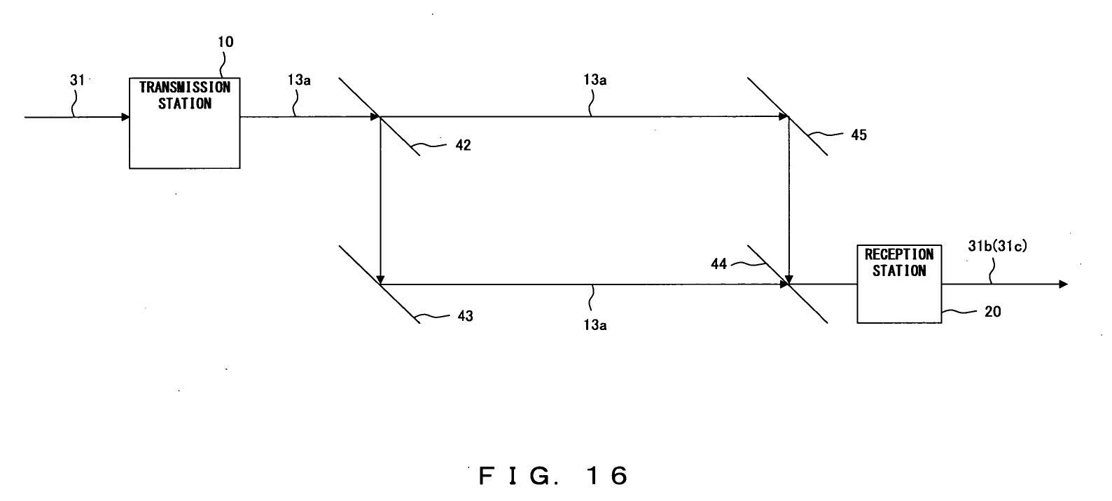

Furthermore, the communication path can be multiplexed using the method exemplified in FIGS. 15 and 16.

In the example shown in FIG. 15, the light 13a emitted from one optical transmission station 10 is branched to a plurality of paths by an optical branch unit 42 and a mirror 43. On the receiver side, a plurality of optical reception stations 20 corresponding to the respective branch paths and the switching unit 41 for selecting one of outputs from the plurality of optical reception stations 20 are provided. The received data 31b and the received clock 31c are retrieved from the light 13a of any one of the paths. In this case, even though one of the plurality of paths of the light 13a is cut off, the light 13a of another path can be received and stable communications can be continued.

In the example shown in FIG. 16, the light 13a output from one optical transmission station 10 is branched to a plurality of paths by the optical branch unit 42 and the mirror 43. On the receiver side, the light 13a branched to a plurality of paths is wavelength-multiplexed by a mirror 45 and a wavelength multiplexing unit 44, and received by one optical reception station 20. The effect is the same as in the case shown in FIG. 15. Furthermore, in the example shown in FIG. 16, only one optical reception station 20 is provided on the receiver side, thereby simplifying the configuration.

Described below is an example of controlling the transmission delay timing of the light 13a in each of the plurality of light emitting elements 13 at the optical transmission station 10 on the basis of the reception status actually measured at the optical reception station 20. Generally, at the communication location of optical spatial communications, the optical transmission station 10 and the optical reception station 20 are provided at each communication location, and information is communicated between the locations. Then, in the example below, the information about the optical reception status in the optical reception station 20 at a host location is transmitted from a host optical transmission station 10 to the destination location through the light 13a. At the destination communication location, the delay timing of the optical transmission station 10 is controlled on the basis of the received reception status.

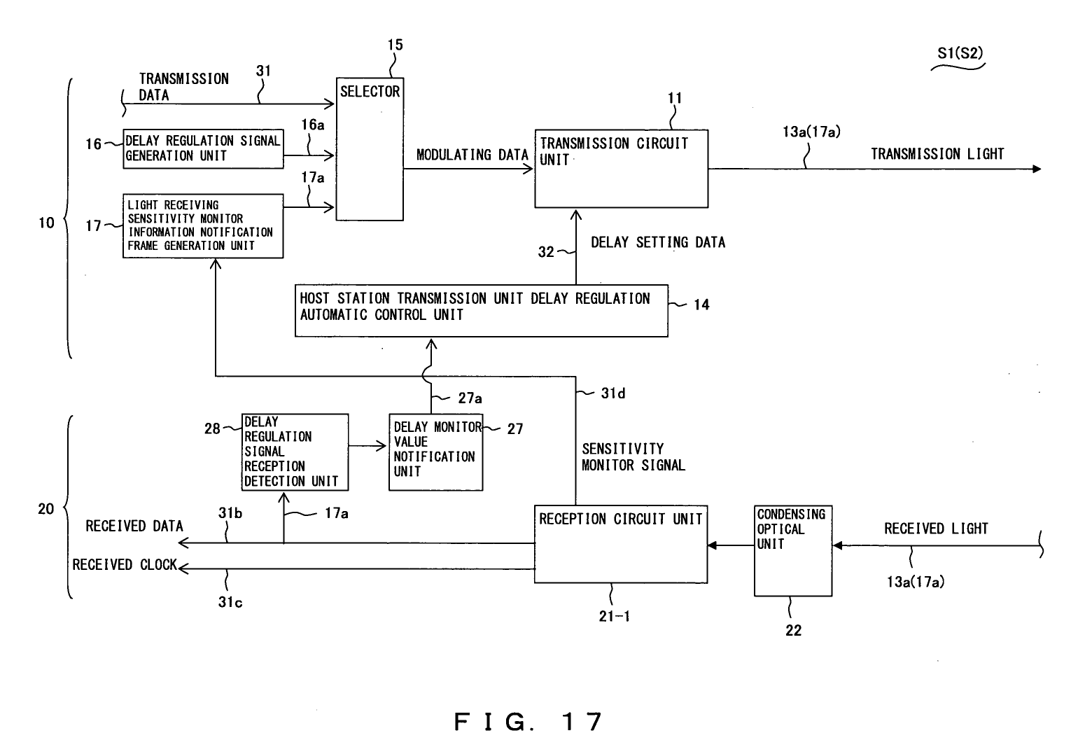

FIG. 17 shows an example of a configuration of an optical transmission station 10 and an optical reception station 20, configuring each communication location S1 and communication location S2 of the optical spatial communication for realizing the delay control described above. Similar components to those shown in FIGS. 1 and 2 are assigned the same reference numerals.

In this case, the optical transmission station 10 also includes, in addition to the configuration shown in FIG. 2, a host station transmission unit delay regulation automatic control unit 14, a delay regulation signal generation unit 16, a light receiving sensitivity monitor information notification frame generation unit 17, and a selector 15.

The delay regulation signal generation unit 16 generates a regulation signal 16a for observation of the reception status.

The light receiving sensitivity monitor information notification frame generation unit 17 generates a light receiving sensitivity monitor information notification frame 17a on the basis of a sensitivity monitor signal 31d obtained from a reception circuit unit 21-1.

The selector 15 selects one of the outputs, the output from the transmission data 31, the output from the delay regulation signal generation unit 16, or the output from the light receiving sensitivity monitor information notification frame generation unit 17, and inputs it into the transmission circuit unit 11.

The host station transmission unit delay regulation automatic control unit 14 generates control setting data 32 for input to the transmission circuit unit 11 on the basis of a delay monitor value 27a obtained from the optical reception station 20 of the host communication location.

In addition to the configuration shown in FIG. 2, the optical reception station 20 is also provided with a reception circuit unit 21-1, a delay monitor value notification unit 27, and a delay regulation signal reception detection unit 28.

The reception circuit unit 21-1 has the sensitivity monitor function of detecting the reception sensitivity of the light 13a by detecting the regulation signal 16a received through the light 13a from the optical transmission station 10 of the destination communication location.

The delay regulation signal reception detection unit 28 has the function of detecting the light receiving sensitivity monitor information notification frame 17a received through the light 13a from the optical transmission station 10 of the destination communication location.

The delay monitor value notification unit 27 has the function of generating the delay monitor value 27a for control of the host station transmission unit delay regulation automatic control unit 14 from the contents of the light receiving sensitivity monitor information notification frame 17a.

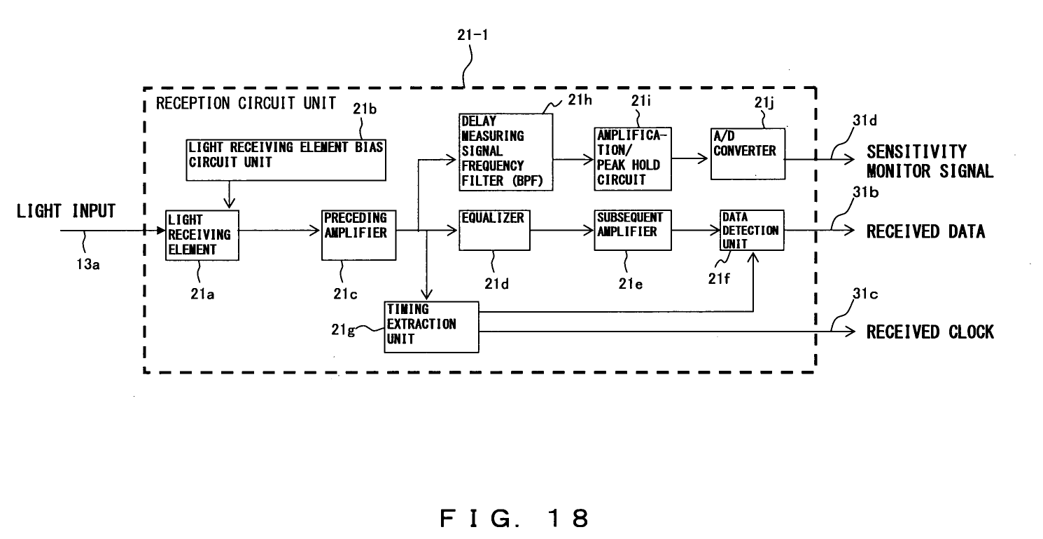

That is, as shown in FIG. 18, in addition to the configuration of the reception circuit unit 21 shown in FIG. 3, a delay measuring signal frequency filter 21h, an amplification/peak hold circuit 21i, and an A/D converter 21j are provided for the reception circuit unit 21-1. The delay measuring signal frequency filter 21h extracts a signal of a specific frequency for testing the sensitivity monitor generated by the delay regulation signal generation unit 16 of the optical transmission station 10 and received by the optical reception station 20, the amplification/peak hold circuit 21i and the A/D converter 21j digitize the signal and output the result as the sensitivity monitor signal 31d. The sensitivity monitor signal 31d is input into the light receiving sensitivity monitor information notification frame generation unit 17 at the transmitter.

The light receiving sensitivity monitor information notification frame generation unit 17 generates the light receiving sensitivity monitor information notification frame 17a, including the information about the sensitivity monitor signal 31d as described above.

Described below is the operation of the configuration shown in FIG. 17. Prior to the communication of the normal transmission data 31, the communication location S1 is provided with an optical transmission station 10 and optical reception station 20, the selector 15 selects the regulation signal 16a output from the delay regulation signal generation unit 16, and the signal is input as transmission data into the transmission circuit unit 11 and is transmitted as the light 13a to the optical reception station 20 of the destination communication location S2.

Upon receipt of the light, the optical reception station 20 of the destination communication location S2 detects the sensitivity monitor signal 31d on the basis of the reception status of the regulation signal 16a, and transmits the information about the sensitivity monitor signal 31d as the light receiving sensitivity monitor information notification frame 17a to the optical reception station 20 at the communication location S1 of the transmission source of the regulation signal 16a through the light receiving sensitivity monitor information notification frame generation unit 17.

In the optical reception station 20 at the communication location S1 of the transmission source of the regulation signal 16a, the delay regulation signal reception detection unit 28 detects the light receiving sensitivity monitor information notification frame 17a received from the destination communication location S2, inputs the light receiving sensitivity monitor information notification frame 17a as the delay monitor value 27a to the host station transmission unit delay regulation automatic control unit 14 through the delay monitor value notification unit 27, and sets the control setting data 32 to be input from the host station transmission unit delay regulation automatic control unit 14 to the transmission circuit unit 11.

Thus, at the communication location S1 as the transmission source of the regulation signal 16a, the delay timing of each light emitting element 13 in the transmission circuit unit 11 is set such that the light receiving sensitivity in the destination communication location S2 at the receiver can be the maximum. A similar process is performed between the communication location S2 and the communication location S1 by switching between the transmitter and the receiver of the regulation signal 16a.

At this time, as an example of a method of obtaining the delay difference between the light emitting elements 13 in transmitting and receiving the regulation signal 16a, one or more groups of the light emitting elements 13 are selected with, for example, all light emitting elements 13 uniformly modulated according to a signal of a constant period (for example, alternating b 1/0). When the delay is shifted, the amount of delay that allows for the maximum amplitude of the alternating 1/0 is selected. The period of the 1/0 alternation is set to a value not falling below the delay difference by a predicted optical path difference.

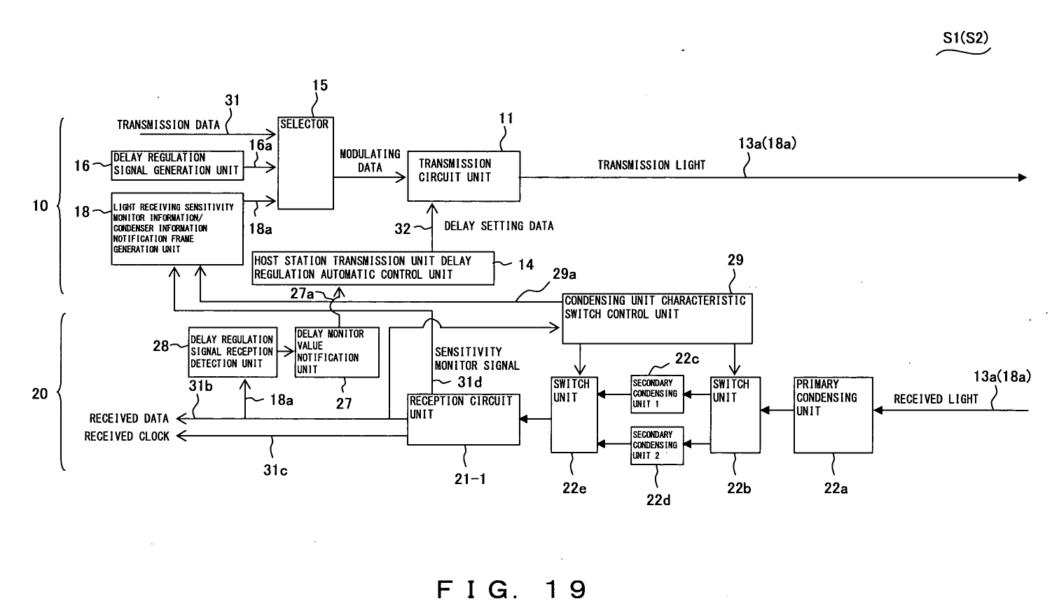

FIG. 19 shows an example of a variation shown in FIG. 17. In the example shown in FIG. 19, the optical reception station 20 further includes a primary condensing unit 22a, a switch unit 22b, a secondary condensing unit 22c, a secondary condensing unit 22d, a switch unit 22e, and a condensing unit characteristic switch control unit 29.

In the optical transmission station 10, the light receiving sensitivity monitor information notification frame generation unit 17 is replaced by a light receiving sensitivity monitor information/condenser information notification frame generation unit 18.

In the optical reception station 20, the switch unit 22b and the switch unit 22e are operated by the condensing unit characteristic switch control unit 29 , so that a path on which the light 13a as received light is condensed is switched to a plurality of paths such as a path leading to the secondary condensing unit 22c and a path leading to the secondary condensing unit 22d.

The switched status of the condensing unit is transmitted as a switched status signal 29a from the condensing unit characteristic switch control unit 29 to the light receiving sensitivity monitor information/condenser information notification frame generation unit 18. The light receiving sensitivity monitor information/condenser information notification frame generation unit 18 generates a light receiving sensitivity monitor information/condenser information notification frame 18a that includes the information of both the sensitivity monitor signal 31d and the switched status signal 29a. The light receiving sensitivity monitor information/condenser information notification frame 18a is transmitted as the light 13a to the optical reception station 20 of the destination communication location through the selector 15 and the transmission circuit unit 11.

That is, between each communication location S1 and communication location S2 provided with an optical transmission station 10 and optical reception station 20, both the status of the regulation signal 16a when the switch is made to the secondary condensing unit 22c or the secondary condensing unit 22d and the path delay characteristic when convergence is performed are interactively transmitted to the destination communication location S2 (S1) using the light receiving sensitivity monitor information/condenser information notification frame 18a.

In the optical reception station 20 of the destination communication location S2 (S1), the delay regulation signal reception detection unit 28 detects the light receiving sensitivity monitor information/condenser information notification frame 18a, and the delay monitor value notification unit 27 notifies the host station transmission unit delay regulation automatic control unit 14 of the delay monitor value 27a and also controls the control setting data 32.

Thus, in each of the communication locations S1 and S2, the light receiving sensitivity monitor information/condenser information notification frame 18a is detected by the delay regulation signal reception detection unit 28 and the delay monitor value notification unit 27, and the setting contents of the control setting data 32 for controlling the transmission circuit unit 11 of the optical transmission station 10 are appropriately changed in accordance with the characteristics of the secondary condensing unit 22c or the secondary condensing unit 22d of the optical reception station 20 in the destination communication location S2 (S1), thereby successfully preventing leakage of the signal data communicated through the light 13a between the communication locations.

It is possible to automatically perform the operation of switching between the secondary condensing unit 22c and the secondary condensing unit 22d in accordance the destination address.

The present invention is not limited to the configuration exemplified in the above-mentioned mode for embodying the present invention, but can be flexibly varied within the scope of the gist of the present invention.

According to the present invention, optical spatial communications can be used for a longer distance with a larger capacity, successfully improve the reliability of communications, and realize the communication capabilities of optical fiber communications without the need to provide conventional optical fibers.

Furthermore, a high confidentiality of information in communications can be guaranteed in optical spatial communications.

Features of the invention are described below.

[1] An optical spatial communication method in which beams of light emitted from a plurality of light emitting elements included in a transmission unit are converged on a reception unit in order to communicate information through the light, comprising a step of

providing a delay difference to the information to be transmitted in the transmission unit on a basis of an optical path difference of each beam of the light from each of the light emitting elements to the reception unit.

[2] The method according to [1], wherein

the light is received through a wavelength filter for selectively passing the light in a specific wavelength range in the reception unit.

[3] An optical spatial communication method in which beams of light emitted from a plurality of light emitting elements included in a transmission unit are converged on a reception unit in order to communicate information through the light, comprising a step of

controlling transmission timing of the light emitted from each of the light emitting elements in the transmission unit on a basis of an optical path difference of each beam of light from each of the light emitting elements to the reception unit.

[4] An optical spatial communication method in which beams of light emitted from a plurality of light emitting elements of a transmission unit are converged on a reception unit in order to communicate information through the light, comprising steps of

preparing the light emitting elements having different center oscillation wavelengths, and

controlling the light on the basis of wavelength dependency of the propagation speed of the light in order to perform accurate information communication through the light when the light is converged at the reception unit.

[5] An optical spatial communication method in which beams of light emitted from a plurality of light emitting elements of a transmission unit are converged on a reception unit in order to communicate information through the light, comprising steps of

setting a plurality of communication paths between the transmission unit and the reception unit, and

controlling transmission modulation of the light in the transmission unit in order to perform accurate information communication when the reception unit is located in a place where the communication paths cross.

[6] An optical transmission apparatus configuring an optical spatial communication systemwith an optical reception apparatus, comprising:

a plurality of light emitting elements;

a delay generation unit for controlling transmission timing of the light from each of the light emitting elements in accordance with a plurality of optical path differences, where beams of light emitted from each of the light emitting elements reach the reception apparatus.

[7] An optical transmission apparatus configuring an optical spatial communication systemwith an optical reception apparatus, comprising:

a plurality of light emitting elements having different center oscillation wavelengths of emitted light; and

a delay generation unit for controlling transmission timing of the light emitted by each of the light emitting elements in order to obtain a normal received waveform when the light is converged at a position of the optical reception apparatus.

[8] An optical reception apparatus configuring an optical spatial communication system with an optical transmission apparatus, comprising:

a condensing unit for converging beams of light emitted by a plurality of light emitting elements provided in the optical transmission apparatus; and

an optical path regulation unit for eliminating each optical path difference of the light between the optical transmission apparatus and the optical reception apparatus.

[9] The apparatus according to [8], further comprising

a wavelength filter eliminating an unnecessary signal component in the light.
   [10] An optical spatial communication system including an optical transmission apparatus and an optical reception apparatus, wherein
the optical reception apparatus comprises an optical path regulation unit for eliminating an optical path difference to receive beams of light emitted by a plurality of light emitting elements provided in the optical transmission apparatus.
   [11] An optical spatial communication system including an optical transmission apparatus and an optical reception apparatus, wherein

the optical transmission apparatus comprises:

a plurality of light emitting elements; and

a delay generation unit for controlling transmission timing of the light emitted by each of the light emitting elements to eliminate an optical path difference of beams of light from the light emitting element to the optical reception apparatus.

[12] The system according to [11], wherein

the optical reception apparatus comprises a reception status notification unit for measuring reception status of the light received from the optical transmission apparatus, and transmitting the result of the measured reception status to the optical transmission apparatus; and

the delay generation unit controls transmission timing of the light emitted by each of the light emitting elements on the basis of the reception status received from the reception status notification unit.

[13] The system according to [11], further comprising

an optical path multiplexing unit for multiplexing an optical path of the light transmitted from the optical transmission apparatus to the optical reception apparatus.

What is claimed is:

1. An optical spatial communication method in which beams of light emitted from a plurality of light emitting elements included in a transmission unit are converged on a reception unit in order to communicate information through the light, comprising a step of
providing a delay difference to the information to be transmitted in the transmission unit on a basis of an optical path difference of each beam of the light from each of the light emitting elements to the reception unit.

2. The method according to claim 1, wherein
the light is received through a wavelength filter for selectively passing the light in a specific wavelength range in the reception unit.

3. An optical spatial communication method in which beams of light emitted from a plurality of light emitting elements of a transmission unit are converged on a reception unit in order to communicate information through the light, comprising steps of
setting a plurality of communication paths between the transmission unit and the reception unit, and
controlling transmission modulation of the light in the transmission unit in order to perform accurate information communication when the reception unit is located in a place where the communication paths cross.

4. An optical transmission apparatus configuring an optical spatial communication systemwith an optical reception apparatus, comprising:
a plurality of light emitting elements having different center oscillation wavelengths of emitted light; and
a delay generation unit for controlling transmission timing of the light emitted by each of the light emitting elements in order to obtain a normal received waveform when the light is converged at a position of the optical reception apparatus.

5. An optical spatial communication system including an optical transmission apparatus and an optical reception apparatus, wherein
the optical transmission apparatus comprises:
a plurality of light emitting elements; and
a delay generation unit for controlling transmission timing of the light emitted by each of the light emitting elements to eliminate an optical path difference of beams of light from the light emitting element to the optical reception apparatus.

6. The system according to claim 5, wherein
the optical reception apparatus comprises a reception status notification unit for measuring reception status of the light received from the optical transmission apparatus, and transmitting the result of the measured reception status to the optical transmission apparatus; and
the delay generation unit controls transmission timing of the light emitted by each of the light emitting elements on the basis of the reception status received from the reception status notification unit.

7. The system according to claim 5, further comprising
an optical path multiplexing unit for multiplexing an optical path of the light transmitted from the optical transmission apparatus to the optical reception apparatus.
